(19) United States
(12) Patent Application Publication
(10) Pub. No.: US 2013/0011718 A1
(43) Pub. Date: Jan. 10, 2013

(54) BATTERY MODULE

(76) Inventors: Yuan-Kun HSIAO, Taoyuan Hsien (TW); Po-Lin Pan, Taoyuan Hsien (TW)

(21) Appl. No.: 13/349,283

(22) Filed: Jan. 12, 2012

(30) Foreign Application Priority Data
Jul. 4, 2011 (TW) 100123569

(51) Int. Cl. H01M 2/10

(52) U.S. Cl. 429/159

(57) ABSTRACT

A battery module including a plurality of cell units is disclosed. Each cell unit has a first surface and a second surface, and the cell units are stacked alone a direction. The cell unit includes a frame, at least one cell and at least two conductors. The frame has at least a first accommodating recess located at the first surface. The cell having two tabs is accommodated in the first accommodating recess. The conductors and the frame are connected at the second surface, and each conductor has a connecting portion located at the first surface. The connecting portions of the two conductors are ultrasound welded with the two tabs respectively. The conductors of adjacent cell units are fixed to each other.

### CROSS REFERENCE TO RELATED APPLICATIONS

This Non-provisional application claims priority under 35 U.S.C. §119(a) on Patent Application No(s). 100123569 filed in Taiwan, Republic of China on Jul. 4, 2011, the entire contents of which are hereby incorporated by reference.

### BACKGROUND OF THE INVENTION

1. Field of Invention

The present invention relates to a battery module and, in particular, to a prismatic battery module.

2. Related Art

Accompanying the progress of technology, various kinds of electronic devices appear everywhere and enrich our lives. Regarding to the mobile electronic devices, the battery is one of the most important component for providing the necessary power source. Generally, the prismatic cell, which has a thin and regular shape, is one of the most common cells. Multiple prismatic cells can construct a single battery module, and the battery module and other components, such as the electronic control module, can form a pack configured for various vehicles.

FIG. 1 shows a conventional prismatic battery module 1, which includes a frame 11, a plurality of cells 12, and a plurality of metal plates 13. The cells 12 are stacked, and each cell 12 has a positive tab 121a and a negative tab 121b. The metal plate 13 is a metal conductor thicker than the tabs, and is screwed to the frame 11 through several screws 14. The positive tab 121a or the negative tab 121b is bended to a surface of the metal plate 13 and then welded to the metal plate 13 by resistance welding. Thus, the metal plates 13 can electrically connect at least two positive tabs 121a or negative tabs 121b of two adjacent cells 12, thereby connecting multiple cells 12 in series.

However, the conventional resistance welding method has many drawbacks. For example, if the thickness of the tabs 121a and 121b is larger than 0.1 mm, the resistance welding may not be successfully performed. Besides, if the welding energy is increased, the welding point may be burned out or broken. In addition, the area of the welding point formed by the resistance welding is usually very small, which means the connected conductive area is very small, so that the welding point may be accumulated with lots of heat when the battery module 1 performs large current charging/discharging. This may cause the overheating or non-uniform temperature distribution of the battery module 1. In particularly, if the battery module 1 is composed of multiple stacked cells 12, the accumulated heat is extremely large, which may affect the operation performance of the entire apparatus and, moreover, cause the damage of the apparatus and dangers. Furthermore, if the tabs 121a and 121b are made of aluminum, it is very hard to weld them with other metal material. Generally, the tabs are usually formed with copper or nickel for the following welding process. However, this may increase the cost and further reduce the available welding area. Besides, in the convention battery module 1, the tabs 121a and 121b must be bended before the welding process, but the bended tabs 121a and 121b may decrease the conductivity.

In addition, the structure of the conventional battery module 1 still has some safety concerns. If the battery module 1 is applied to a vehicle, it is usually positioned in a vibration environment for a long term, which may cause a huge challenge for the reliability of the welding strength. Besides, many small screws 14 are used to fix the metal plates 13 on the frame 11, and their positions are very close. Thus, the assembling process with the screws 14 is difficult and may easily cause the short circuit. Moreover, the small screws 14 may be loosen in the vibration environment.

In FIG. 1, the metal plates 13 can connect six cells 12 in series. FIG. 2A shows a metal plate 13 as shown in FIG. 1, and FIG. 2B shows a metal plate 13a for connecting two cells 12 in series. If the number of the cells 12 in a battery module is changed for different application requirements, the structure and design of the metal plate 13 must be modified accordingly. Since the metal plate 13 with old structure and design may not be used in new battery module design, the cost for preparing various kinds of metal plate is needed and is thus increased.

Therefore, it is an important subject of the present invention to provide a battery module that can prevent the drawbacks of the resistant welding, enhance the performance and safety thereof, increase the assembling efficiency, product reliability and application flexibility by modifying the assembling structure thereof, and decrease the production cost.

### SUMMARY OF THE INVENTION

In view of the foregoing subject, an objective of the present invention is to provide a battery module that can prevent the drawbacks of the resistant welding, enhance the performance and safety thereof, increase the assembling efficiency, product reliability and application flexibility by modifying the assembling structure thereof, and decrease the production cost.

To achieve the above objective, the present invention discloses a plurality of cell units, which are stacked alone a direction. Each cell unit has a first surface and a second surface, and includes a frame, at least one cell, and at least two conductors. The frame has at least one first accommodating recess located at the first surface. The cell is accommodated in the first accommodating recess, and has two tabs. The conductors and the frame are connected at the second surface, and each conductor has a connecting portion located at the first surface. The conductors of the adjacent cell units are fixed to each other.

In one embodiment, the frame further has at least two second accommodating recesses located at the second surface, and the two conductors are disposed in the two second accommodating recesses respectively.

In one embodiment, the conductor has at least one fixing portion connecting with the frame by locking, screwing, gluing, welding or their combination.

In one embodiment, the frame further has at least one fastening element for fastening the adjacent cell units.

In one embodiment, the cell is glued in the first accommodating recess.

In one embodiment, the two tabs include a positive tab and a negative tab. The conductors for connecting the positive tabs are fixed to each other, and the conductors for connecting the negative tabs are fixed to each other. The number of the conductors is corresponding to the number of the cells. The conductors are fixed to each other by locking, screwing, welding, or their combination.

In one embodiment, when the cell unit includes a plurality of cells, the battery module further includes at least one connecting element located at the second surface for connecting the adjacent cells in series. The connecting element connects the adjacent cells in series by locking, screwing, welding, or their combination, and at least one of the conductors connecting to the positive tab of one of the cells is electrically connected to at least one of the conductors connecting to the negative tab of the adjacent cell. In a preferred embodiment, each of the conductors of the cell units has a through hole disposed at the second surface, and the connecting element is screwed with the conductors through the through holes. Preferably, the battery module further includes a divider line connecting with the conductors through the through holes.

In one embodiment, when the conductors of the first and last cell units are disposed in the second accommodating recesses, the conductors are concaved with respective to the frames of the first and last cell units.

In one embodiment, the connecting portion of the conductor is a concave portion, which is preferably a finish-milled concave portion. In two adjacent conductors, the surface of the concave portion of a first conductor is parallel to the surface of a second conductor connected with the first conductor.

In one embodiment, the connecting portions of the two conductors are ultrasound welded with the two tabs respectively.

As mentioned above, the battery module of the present invention can be assembled by connecting the conductor with the conductor, the conductor with the frame, and the frame with the frame. This design can make the assembling procedure of the battery module having multiple cell units easier, thereby increasing the assembling stability, assembling efficiency, and product reliability. Besides, the number of the screws used for connecting the parallel cell units can be sufficiently reduced. Moreover, when the number of the cell units is larger, the cost efficiency is higher due to the lower manufacturing cost and the decreased assembling time. In addition, since the tabs and conductors are connected by ultrasound welding, the heat generated at the welding point is avoided, the conductive area is increased, and the performance and safety of the battery module are enhanced, thereby preventing the drawbacks of the resistance welding. Besides, different numbers of cell units are needed for various applications. The battery module of the present invention can be configured with different numbers of cell units without modifying the conductors, thereby providing a flexible design and thus reducing the cost for developing different molds for different conductors.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic diagram of a conventional battery module;

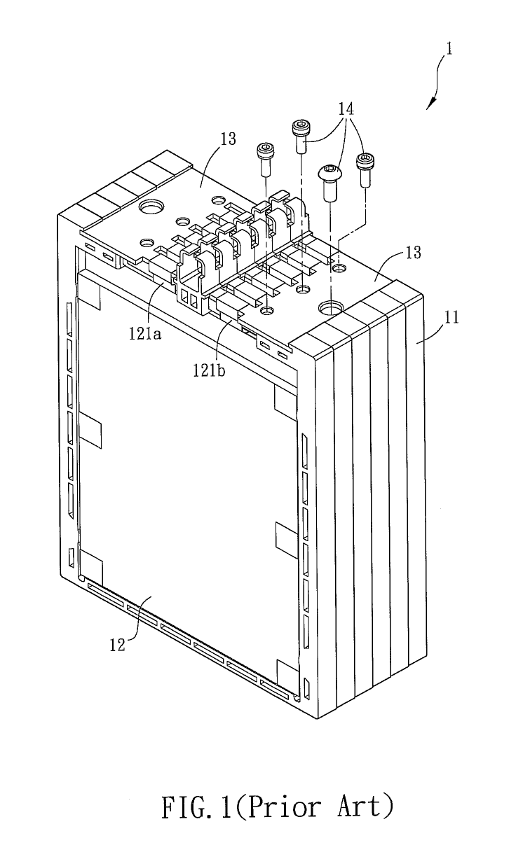

FIGS. 2A and 2B are schematic diagrams showing different aspects of the conventional metal plates;

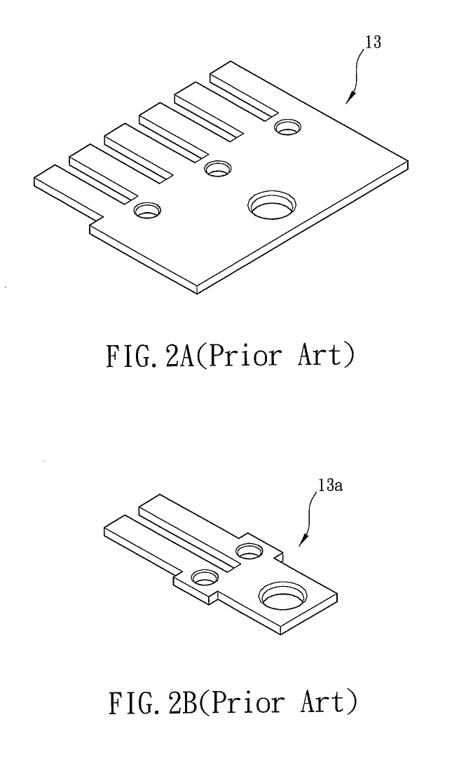

FIG. 3A is a schematic diagram of an assembled battery module according to a preferred embodiment of the present invention;

FIG. 3B is a partial exploded view of the battery module according to the embodiment of the present invention;

FIG. 4 is a schematic diagram showing the frame of the battery module according to the embodiment of the present invention; and

FIG. 5 is a partial exploded view of another battery module according to the embodiment of the present invention.

### DETAILED DESCRIPTION OF THE INVENTION

The present invention will be apparent from the following detailed description, which proceeds with reference to the accompanying drawings, wherein the same references relate to the same elements.

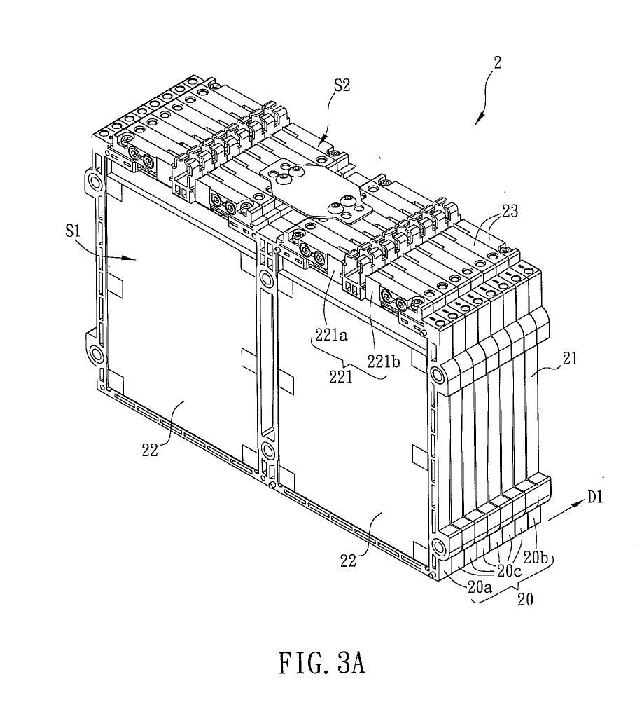

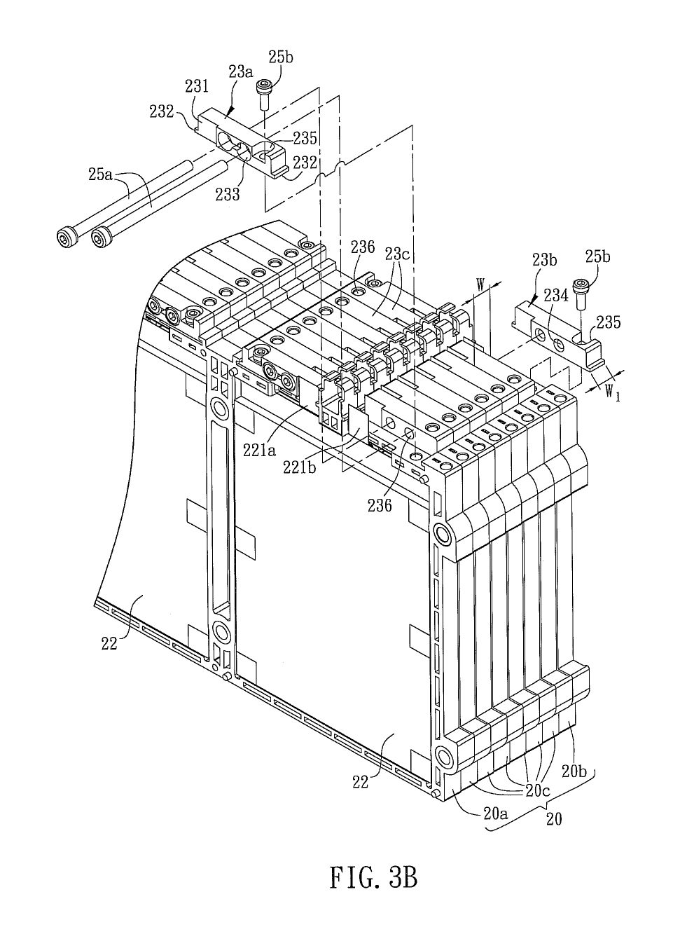

FIG. 3A is a schematic diagram of an assembled battery module 2 according to a preferred embodiment of the present invention, and FIG. 3B is a partial exploded view of the battery module 2. Referring to FIGS. 3A and 3B, the battery module 2 includes a plurality of cell units 20, which are stacked alone a direction Dl. Each cell unit 20 has a first surface S1 and a second surface S2, and includes a frame 21, at least one cell 22, and at least two conductors 23. In this embodiment, the battery module 2 includes 8 battery units 20, and each battery unit 20 includes two cells 22. The surface of the cell 22 is covered by insulating tapes for increasing its pressure resistance. The battery module 2 can be used as a vehicle battery module. In practice, multiple battery modules 2 are stacked to form a battery set for charging or discharging. In this embodiment, the suitable cell 22 is, for example but not limited to, a prismatic cell such as a lithium prismatic cell.

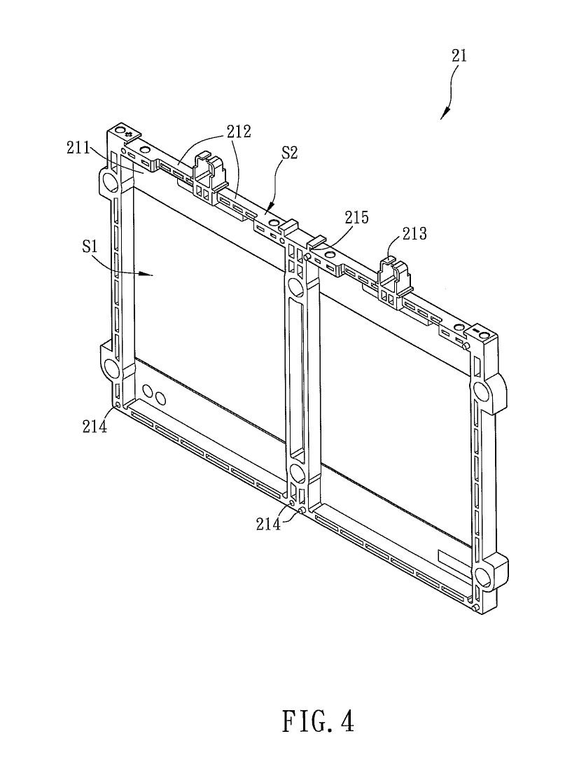

FIG. 4 is a schematic diagram showing the frame 21 of the battery module 2 according to the embodiment of the present invention. As shown in FIG. 4, the frame 21 has at least one first accommodating recess 211 located at the first surface S1. The cell 22 is accommodated in the first accommodating recess 211. In this embodiment, the frame 21 further includes at least two second accommodating recesses 212 located at the second surface S2. The two conductors 23 are disposed in the two second accommodating recesses 212 respectively. The first accommodating recess 211 and the second accommodating recesses 212 can be designed with respective to the shapes of the cell 22 and the conductor 23. The frame 21 may further include a trace portion 213 located at the second surface S2 and between the two conductors 23. The trace portion 213 can isolate two conductors 23 and facilitate to arrange and fix the wires of the battery module 2. When the cell units 20 are stacked, at least one fastening element 214 of the frame is configured to fasten the adjacent cell units 20. In this case, the fastening elements 214 include four protruding portions and four concave portions, which are disposed at the four corners and two long sides of the frame 21. Although only the fastening elements 214 of the first surface S1 of the cell unit 20 is shown in the figures, it should be understood that the other surface opposite to the first surface S1 is relatively configured with fasten elements 214 for assembling this cell unit 20 with another one.

The cell 22 is accommodated in the first accommodating recess 211, and each cell 22 has two tabs 221 including a positive tab 221a and a negative tab 221b. The conductor 23 has a connecting portion 231 located at the first surface S1, and the connecting portions 231 of two conductors 23 are ultrasound welded with two tabs 221 respectively. That is, the number of the conductors 23 is the same as that of the tabs 221 of the cells 22. In other words, the number of the conductors 23 varies depending on the number of the cells 22 configured in the cell units 20. In this embodiment, the connecting portion 231 is a concave portion, and is preferably a finish-milled concave portion, so that it is simple to dispose the tab 221 thereon and perform the following welding process. In addition, the roughness of the contact surfaces of the connecting portion 231 and the tab 221 can affect the ultrasonic welding, so that the connecting portion 231 and the tab 221 are preferably processed by CNC. Preferably, the contact surfaces of the connecting portion 231 and the tab 221 are planar and in parallel to each other. Besides, in order to increase the vibration resistance of the battery module 2 and prevent the tabs 221 connecting the cell 22 and the conductor 23 from break, the glue can be applied in the first accommodating recess 211 for fixing the cell 22.

The conductor 23 can be a metal block, which is made of conductive metals such as aluminum or copper. The conductor 23 is connected with the frame 21 at the second surface S2. Since the tab 221 can be ultrasonic welded with the connecting portion 231 at the first surface S1 of the cell unit 20, the assembling steps of the cell unit 20, including the steps of fixing the cell 22 on the frame 21, disposing the conductor 23 in the second accommodating recess 212, and ultrasonic welding the tab 221 with the conductor 23, can be all carried out on the first surface S1. Thus, it is unnecessary to turn over the cell unit 20, and the jigs for positioning the working piece are also not needed. Accordingly, the assembling efficiency can be increased, and the assembling cost can be decreased.

To be specified, the ultrasonic welding can connect different metal materials, the thickness of the welding base can be 0.6 mm or more (depending on the material and welding energy), and the area of the welding point can reach a range with a diameter of 16 mm. The welding area and density between the tab 221 and the conductor 23 by using the ultrasonic welding can be sufficiently greater than those by using the conventional resistance welding. Accordingly, the connection between the tab 221 and the conductor 23 is stronger than the inherent material strength, and the heat caused by the small welding area can be decreased. Moreover, since the conductor 23 is a metal block, the heat capacity and heat-dissipating area thereof are larger than those of a metal plate. This configuration can prevent the generated heat from flowing back the cell 22, which may decrease the lifetime of the cell 22.

When the cell units 20 are stacked, the conductors 23 of adjacent cell units 20 are connected and fixed to each other. The conductors 23 for connecting the positive tabs 221a are connected and fixed to each other, and the conductors 23 for connecting the negative tabs 221b are connected and fixed to each other. Thus, the cell units 20 can be connected in parallel. Preferably, two screws 25a are used to screw the conductors 23 of each cell unit 20 through the first surface S1 of the frame 21. Of course, the conductors 23 can be connected and fixed by locking, gluing, welding or their combination.

In this embodiment, the conductor 23 may further have at least one fixing portion 232, so that the conductor 23 and the frame 21 can be connected at the second surface S2 through the fixing portion 232. For example, the fixing portion 232 includes two protruding portions, which can lock with corresponding two concave portions 215 of the second accommodating recesses 212. The connecting method is, for example but not limited to, locking, screwing, gluing, welding or their combination. Alternatively, two screws 25b are used to screw the conductors 23a and 23b of the first cell unit 20a and the last cell unit 20b, thereby screwing the cell units 20a and 20b in the second accommodating recesses 212. This configuration can enhance the fixing strength of the entire structure. The above-mentioned assembling method can sufficiently decrease the amount of the required screws. No matter how many cell units 20 are connected in the battery module 2, only 16 screws are needed to fix all components. Besides, the connection stability and reliability can be improved. Thus, this configuration is particularly suitable for the battery module 2 with many cell units 20.

In addition, the width W1 of the conductors 23a and 23b of the first cell unit 20a and the last cell unit 20b may be smaller than the width W of the other conductors 23c. Accordingly, when the conductors 23a and 23b are disposed in the second accommodating recesses 212, they are concaved with respective to the frames 21 of the first cell unit 20a and the last cell unit 20b. When several battery modules 2 are connected in series to form a battery set, the gaps may be remained between the conductors 23a and 23b of one battery module 2 and the adjacent battery module. This can prevent the damage and short circuit caused by the undesired electrical contact. Besides, in two adjacent conductors 23, the surface of the concave portion of a first conductor 23 is parallel to the surface of a second conductor 23 connected with the first conductor 23.

Accordingly the assembling structure and method described above, the fine connections between the conductor 23 and the frame 21, the cell 22 and the frame 21, the conductor 23 and the cell 22, and the conductor 23 and the conductor 23, can be provided.

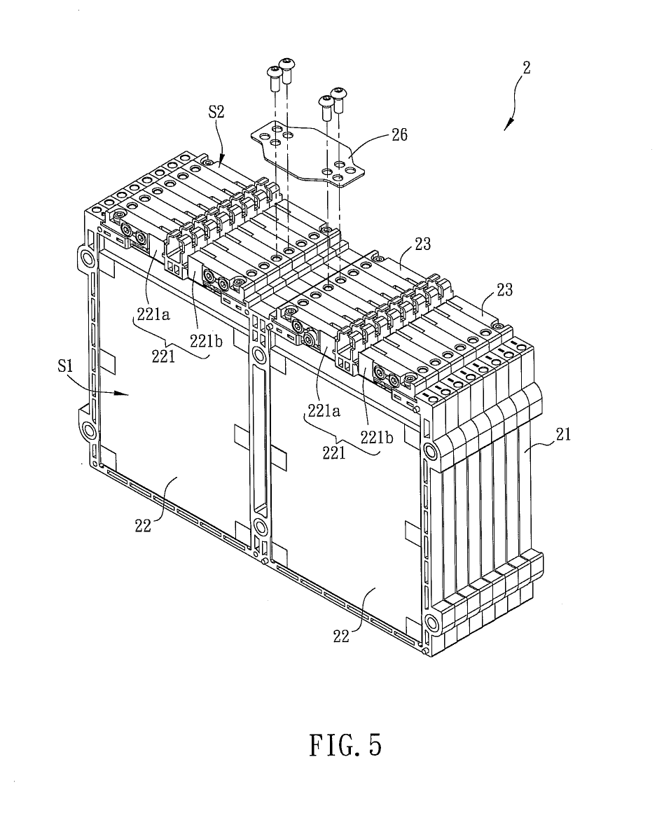

The above embodiment shows the parallel connection configuration and fixing structure of the battery module 2, and the serial connection configuration of the battery module 2 including the cell units 20, each of which has a plurality of cells 22, will be described hereinafter. Referring to FIG. 5, each cell unit 20 includes two cells 22 for example. In order to connect the cells 22 of the cell unit 20 in series, the battery module 2 preferably further includes at least one connecting element 26 (e.g. a conductive metal plate) located at the second surface S2 of the cell unit 20. One end of the connecting element 26 is electrically connected to the conductor 23 connecting to the positive tab 221a of one cell 22, and the other end thereof is electrically connected to the conductor 23 connecting to the negative tab 221b of the other cell 22. This configuration can connect the adjacent cells 22 in series. Similarly, if the cell unit 20 includes three cells 22, two connecting elements 26 are used to connect the cells 22 in series. Herein, the connecting element 26 connects the adjacent cells in series by screwing, so that the conductor 23 connecting to the positive tab 221a of one cell 22 is electrically connected to the conductor 23 connecting to the negative tab 221b of the adjacent cell 22. Besides, the cells 22 can also be connected in series by locking, screwing, welding, or their combination. In this embodiment, the connecting element 26 further connects four conductors 23 of two cells 22 in two cell units 20. To be noted, the shape, size and amount of the connecting element 26 and the number of the connected conductors 23 are not limited to the above embodiment, and they can be modified depending on the stability of the connecting structure.

In addition, the battery module 2 of the present embodiment is advantaged that the conductors 23 do not have to be modified while the number of the parallel connected cell units 20. The conductors 23 for the cell unit 20 have the same shape and size. However, some conductors 23 must be drilled to form holes depending on the screws for connecting the separate components.

With reference to FIG. 4, the conductors 23a and 23b of the first and last cell units 20a and 20b must be drilled to form two countersinking holes 233 and two teeth holes 234. The countersinking holes 233 and the teeth holes 234 are configured at the first surfaces S1 of the cell units 20a and 20b. Regarding to the other cell unit 20c, the first surface S1 of the conductor 23c thereof must be drilled to form a through hole 236, so that the conductors 23 of all cell units 20 can be screwed and fixed. Besides, the second surface S2 of each of the conductors 23a and 23b of the first and last cell units 20a and 20b must be drilled to form a long hole 235, so that the conductors 23a and 23b can be screwed with the frame 21. The long holes 235 are configured to eliminate the accumulated tolerances of the thicknesses of the conductors 23 while multiple cell units 20 are stacked. As shown in FIG. 5, the conductor 23c of the other cell unit 20c may further include a through hole 236 disposed at the second surface S2. The connecting element 26 can screw the conductors 23 through the through hole 236 or the long hole 235. Besides, the battery module 2 may further include a divider line (not shown) connecting with the conductors 23 through the through hole 236 or long hole 235 for dividing the voltage of the battery module 2.

In summary, the battery module of the present invention can be assembled by connecting the conductor with the conductor, the conductor with the frame, and the frame with the frame. This design can make the assembling procedure of the battery module having multiple cell units easier, thereby increasing the assembling stability, assembling efficiency, and product reliability. Besides, the number of the screws used for connecting the parallel cell units can be sufficiently reduced. Moreover, when the number of the cell units is larger, the cost efficiency is higher due to the lower manufacturing cost and the decreased assembling time. In addition, since the tabs and conductors are connected by ultrasound welding, the heat generated at the welding point is avoided, the conductive area is increased, and the performance and safety of the battery module are enhanced, thereby preventing the drawbacks of the resistance welding. Besides, different numbers of cell units are needed for various applications. The battery module of the present invention can be configured with different numbers of cell units without modifying the conductors, thereby providing a flexible design and thus reducing the cost for developing different molds for different conductors.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A battery module, comprising:
a plurality of cell units, wherein each of the cell units has a first surface and a second surface, and the cell units are stacked alone a direction, each of the cell units comprising:
a frame having at least a first accommodating recess located at the first surface;
at least one cell accommodated in the first accommodating recess, wherein the cell has two tabs; and
at least two conductors, wherein the conductors and the frame are connected at the second surface, and each of the conductors has a connecting portion located at the first surface;
wherein, the conductors of the adjacent cell units are fixed to each other.

2. The battery module according to claim 1, wherein the frame further has at least two second accommodating recesses located at the second surface, and the two conductors are disposed in the two second accommodating recesses respectively.

3. The battery module according to claim 1, wherein the conductor has at least one fixing portion connecting with the frame by locking, screwing, gluing, welding or their combination.

4. The battery module according to claim 1, wherein the frame further has at least one fastening element for fastening the adjacent cell units.

5. The battery module according to claim 1, wherein the cell is glued in the first accommodating recess.

6. The battery module according to claim 1, wherein the two tabs include a positive tab and a negative tab, the conductors for connecting the positive tabs are fixed to each other, the conductors for connecting the negative tabs are fixed to each other, and the number of the conductors is corresponding to the number of the cells.

7. The battery module according to claim 6, wherein the conductors are fixed to each other by locking, screwing, welding, or their combination.

8. The battery module according to claim 6, wherein when the cell unit comprises a plurality of cells, the battery module further comprises at least a connecting element located at the second surface for connecting the adjacent cells in series.

9. The battery module according to claim 8, wherein the connecting element connects the adjacent cells in series by locking, screwing, welding, or their combination, so that at least one of the conductors connecting to the positive tab of one of the cells is electrically connected to at least one of the conductors connecting to the negative tab of adjacent one of the cells.

10. The battery module according to claim 8, wherein each of the conductors of the cell units has a through hole disposed at the second surface, and the connecting element is screwed with the conductors through the through holes.

11. The battery module according to claim 8, wherein each of the conductors of the cell units has a through hole disposed at the second surface, and the battery module comprises a divider line connecting with the conductors through the through holes.

12. The battery module according to claim 2, wherein when the conductors of the first and last cell units are disposed in the second accommodating recesses, the conductors are concaved with respective to the frames of the first and last cell units.

13. The battery module according to claim 1, wherein the connecting portion of the conductor is a concave portion.

14. The battery module according to claim 13, wherein in two adjacent conductors, the surface of the concave portion of one of the conductors is parallel to the surface of the other conductor connected with the conductor.

15. The battery module according to claim 1, wherein the connecting portions of the two conductors are ultrasound welded with the two tabs respectively.
